(19) United States
(12) Patent Application Publication
(10) Pub. No.: US 2003/0131654 A1
(43) Pub. Date: Jul. 17, 2003

(54) Method and apparatus for monitoring building air flow

(75) Inventors: Gray J. Robertson, Fairfax, VA (US); John C. Madaris, Woodbridge, VA (US); Anthony J. Robertson, Galston (AU); Guy S. M. Turner, Foothill Ranch, CA (US); Brian Roseworne, Narraweena (AU)

Correspondence Address: Bernard L. Kleinke, Duckor Spradling & Metzger, 401 West A Street, Suite 2400, San Diego, CA, 92101-7915, US

(73) Assignee: Healthy Buildings International, Inc.

(21) Appl. No.: 10/304,637

(22) Filed: Nov. 25, 2002

Related U.S. Application Data
(60) Provisional application No. 60/333,326, filed on Nov. 26, 2001.

(51) Int. Cl. G01N 30/00

(52) U.S. Cl. 73/23.2; 73/28.04

(57) ABSTRACT

According to an embodiment of the invention, there is provided a method and apparatus for monitoring the air quality, whereby removable filter cartridges or modules containing a monitoring filter can be safely removed and inspected to determine whether or not unsafe pollutants have been introduced to the air within a confined structure such as a building. Another embodiment relates to a valve member for self-actuating when the module is removed to examine the monitoring filter.

### RELATED APPLICATIONS

This application claims priority to U.S. provisional patent application Serial No. 60/333,326, filed Nov. 26, 2001, and entitled METHOD AND APPARATUS FOR MONITORING BUILDING AIR FLOW, which is incorporated herein by reference in its entirety.

### FIELD OF THE INVENTION

The present invention relates in general to a method and apparatus for monitoring air flow in buildings or other confined environments. It more particularly relates to such a method and apparatus for monitoring air flow in buildings or the like, for the presence of possible bio-chemical or chemical impurities or other harmful or toxic substances.

### BACKGROUND ART

The information contained in this section relates to the background of the art of the present invention without any admission as to whether or not it legally constitutes prior art.

In the past, air flow has been monitored in buildings for the purpose of providing an indication of the effectiveness of the filters employed for filtering the air in the building. Such techniques included the use of small air filters which could be examined at various locations in the building to determine how effectively the main air filters were functioning to trap dust and dirt particles. If the small monitoring filters indicated that there was an excess of dust and dirt particles in the air, the main air filters for the buildings would either be cleaned or replaced to provide more effective and efficient air cleaning.

Currently, there has been an increase in concern for the safety of building occupants from terrorist attacks employing biochemical and chemical agents which can harm the occupants of the building. In an attempt to address these concerns, buildings are currently employing expensive filters capable of capturing pollutants including dangerous bacteria and fungi spores.

While such filters are usually satisfactory for many applications to help guard against biochemical and chemical agents, it can be dangerous to maintenance personnel attempting to clean or replace the filters. In this regard, the filters may effectively collect dangerous pollutants from the air entering the building and thus protect the occupants of the building. However, such a buildup of dangerous pollutants can jeopardize the health and wellbeing of the maintenance personnel when such filters are being maintained.

Thus, it would be highly desirable to have a new and improved apparatus and method for monitoring building air flow.

### DESCRIPTION OF THE DRAWINGS

The following is a description of the drawings of certain embodiments of the present invention:

FIG. 1 is a diagrammatic sectional, elevational view of an air quality monitoring system and apparatus employed in a building according to an embodiment of the present invention;

FIG. 2 is an enlarged sectional view of an apparatus for monitoring building air flow according to an embodiment of the invention and as may be employed in the system of FIG. 1;

FIG. 3 is a fragmentary sectional view of the apparatus of FIG. 2, illustrating the removal of an inner filter cassette;

FIG. 4 is a sectional view of another apparatus for monitoring building air flow according to another embodiment of the invention and as may be employed in the system of FIG. 1;

FIG. 5 is a fragmentary sectional view of the apparatus of FIG. 4 illustrating the removal of an inner filter cassette; and

FIG. 6 is a diagrammatic sectional, elevational view of an air quality monitoring system and apparatus employed in a building according to another embodiment of the invention.

### DETAILED DESCRIPTION OF PREFERRED EMBODIMENTS

According to an embodiment of the invention, building air quality is monitored to determine whether or not dangerous pollutants such as bio-chemical or chemical agents have been introduced to the air within a confined structure such as a building.

According to an embodiment of the invention, there is provided a method and apparatus for monitoring the air quality, whereby removable filter cartridges or modules containing a monitoring filter can be safely removed and inspected to determine whether or not unsafe pollutants have been introduced to the air within a confined structure such as a building. Another embodiment relates to a valve member for self-actuating when the module is removed to examine the monitoring filter.

According to another embodiment of the invention, the air quality entering the building or other confined structure is monitored for unsafe pollutants so that a main air filter for the confined structure can be determined to be safe or not for maintenance personnel to replace or clean the filter.

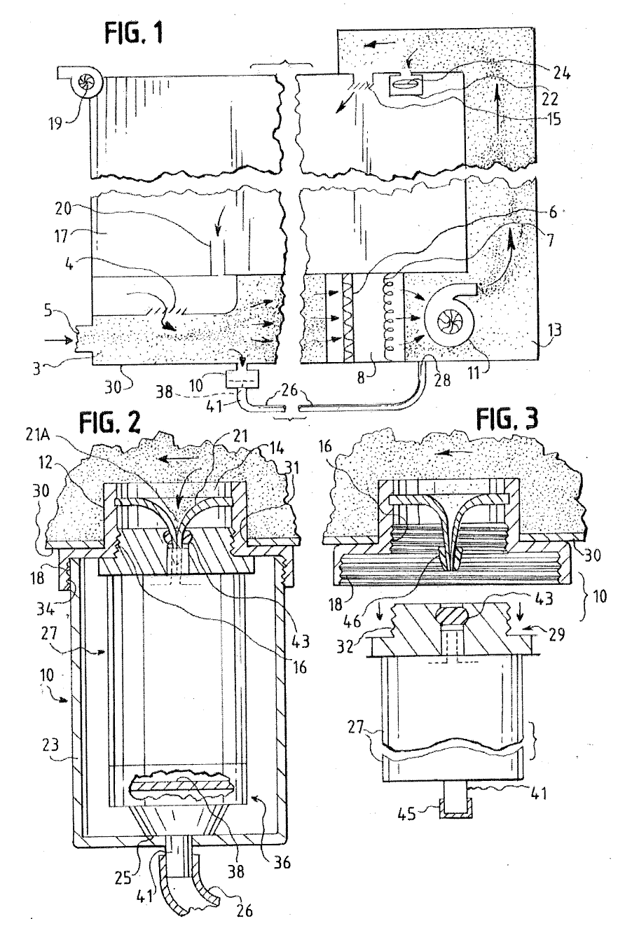

Referring now to FIG. 1 of the drawings, there is shown a system 1 which is constructed in accordance with an embodiment of the invention, and which is installed within a confined structure such as a building 2. The air handling system of the building 2 includes an air conduit in the form of an air duct or a pre-filter chamber 3 where return air via an air damper 11 is combined with outside air from an outside air damper 5.

A filter 6 and a cooling or heating coil 7 are disposed within a filter chamber 8. The filter may be of the type which can filter out dangerous pollutants such as biochemical and chemical agents.

A fan 11 is mounted in a fan chamber 13 for circulating air under pressure to the building such as through a diffuser 15 into a room 17 or other such space. A vent fan 19 exhausts air from the room 17, and cold air returns through a cold air return 20 to the pre-filter chamber 3.

An air quality monitoring apparatus 22 having a filter 24 is disposed within the room 17 for monitoring the quality of the air delivered from the fan 11. If the filter 24 is determined to be sufficiently clogged, then this serves as an indication that the main filter 6 requires cleaning or replacement.

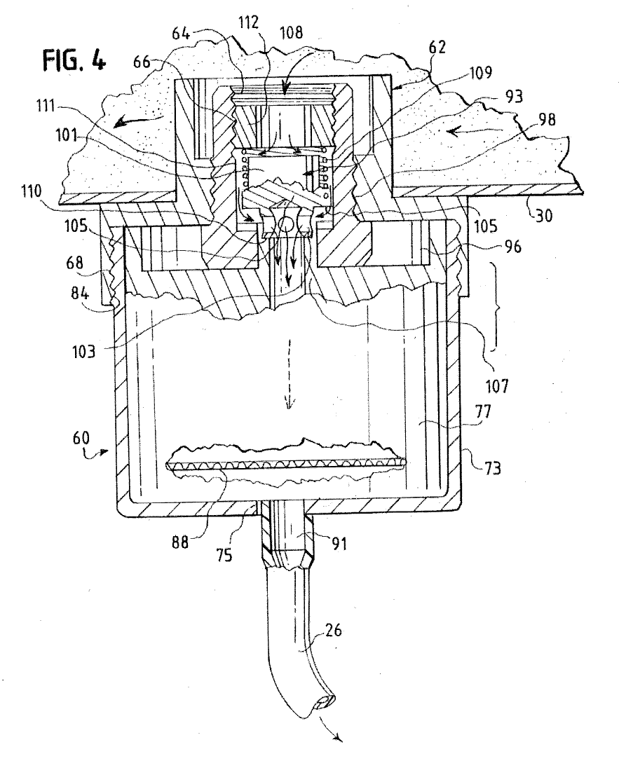

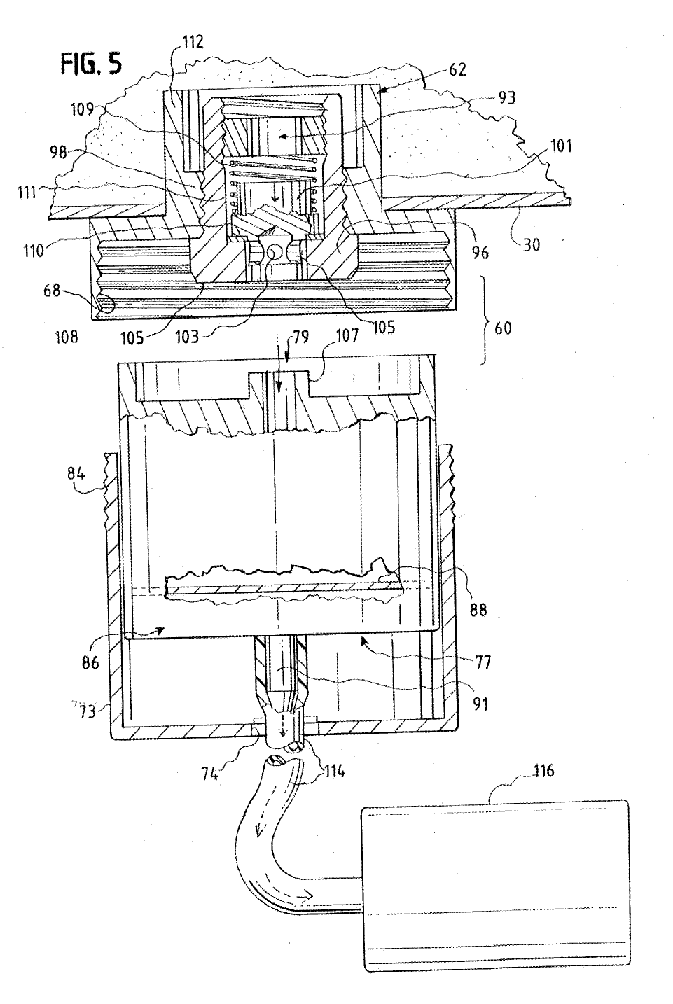

In accordance with an embodiment of the invention, an air quality monitoring apparatus 10 monitors the quality of the outside air entering the pre-filtration chamber 3. It should be understood that another air quality monitoring apparatus 60 (FIGS. 4 and 5) may also be employed in place of the apparatus 10 (FIGS. 2 and 3) and is currently preferred. The purpose of the monitoring apparatus is to determine whether or not the main air filter 6 is safe for maintenance personnel to clean or replace. The monitoring apparatus 10 (or 60) has a removable filter cartridge or module which can be inspected prior to performing maintenance on the main air filter 6. The apparatus 10 and 60 each include a self-actuating valve member as well, and will be described hereinafter in greater detail.

Since there is low pressure at the inside of the pre-filter chamber 3, in order to draw air samples into the monitoring apparatus 10, a conduit or tube 26 connects an outlet 41 of the apparatus 10 in fluid communication with an inlet 28 of the fan chamber 13 between the filter chamber 8 and the inlet to the fan 11. In this manner, air is drawn into the fan 11 from the pre-filter chamber 3 through the apparatus 10 and the tube 26. Thus, the apparatus 10 and the tube 26 serve as a bypass to the filter 6 to effectively collect air samples at the apparatus 10 as hereinafter described in greater detail.

FIG. 2 illustrates one embodiment of the air flow monitoring apparatus 10, which includes a base portion or cap 12 adapted to engage, for example, an air duct or the pre-filter wall 30 at an opening 31 therein, and may depend vertically therefrom. Other orientations may also be possible. The base portion 12 has an monitor inlet 14 through which air from the pre-filter chamber 3 may enter the air flow monitoring apparatus 10.

The base portion 12 may be made of a variety of materials such as metal or plastic. Preferably, the base portion 12 has a cylindrical configuration, but other configurations are also contemplated.

The base portion 12 is provided with an internal threading 16 for engaging a filter module or cartridge 27. The internal threading 16 is adapted to engage an external threading 32 (FIG. 3) provided on the filter module or cartridge 27. In other embodiments, the threading may be replaced with other mechanisms for engaging and securing the filter module 27 to the base portion 12. An internal threading 18 is also provided on the base portion 12 to engage an external threading 34 provided on a monitor housing 23. In other embodiments, the engagement of the base portion 12 to the monitor housing 23 may be accomplished by, for example, a system of slots and corresponding notches. The engagement of the base portion 12 to both the monitor housing 23 and the filter module 27 is adapted to allow easy removal and reinstallation of the components.

The base portion 12 is also provided with a needle inlet 21 adapted to direct the air flow from the air duct through a needle opening 21a.

The housing 23 may be made of a variety of materials such as metal or plastic. In a preferred embodiment, the housing is made of a lightweight, metallic material such as aluminum. The housing 23 is provided with an exhaust opening 25 adapted to direct the air out of the air flow monitoring apparatus 10.

The filter module 27 has an inlet portion 29 adapted to receive air flow into the filter module 27. As noted above, the internal portion 29 is provided with external threading 32 for engaging the internal threading 16 on the base portion 12. In other embodiments, a frictional engagement may be provided for securing the filter module 27 to the base portion 12.

The inlet portion 29 is also provided with a valve member in the form of a rubber septum 43 in an air flow channel or passage according to an embodiment of the invention. The rubber septum 43 is adapted to be pierced by the needle inlet 21 of the base portion 12 when the base portion 12 and the filter module 27 are engaged to open the valve member 43 by piercing it, during normal operation. The rubber septum 43 is adapted to reseal to provide a self-actuating valve when the base portion 12 and the filter module 27 are disengaged and the needle inlet 21 is withdrawn from the rubber septum 43 to close the valve member. In this manner, any samples collected in the filter module 27 from the air flow duct are prevented from escaping through the inlet portion 29 after the filter module 27 is removed from the base portion 12.

The filter module 27 also includes a filter portion 36 which is provided with a monitoring filter 38 for trapping particles such as dust or bacteria. The filter 38 may be adapted for particular uses as needed. For example, one filter may be used if the air flow monitor is to monitor the quality of air relating to dust and/or other pollutants, while another filter may be used for monitoring the existence of biochemical threats such as anthrax spores.

The filter module 27 also includes an outlet portion 41 through which filtered air is directed out of the filter module 27. The outlet portion 41 may include a nozzle that directs the air through the exhaust opening 25 in the housing 23. When the filter module 27 is removed from the base portion 12, the outlet portion 41 may be sealed with a cap 45 (FIG. 3).

Thus, the quality of the air flow may be monitored by use of the disclosed air flow monitoring apparatus 10. The filter module 27 may be replaced on a regular basis with the used filter module 27 being sent to a laboratory or other facility for analysis. By providing a sealing septum 43 on one end and a sealing cap 45 on the other end, escape of contents of the filter module may be prevented, for example, during transport to a laboratory or the like. In one embodiment, the filter module 27 may be placed in an envelope for mailing to a laboratory or other facility.

FIGS. 4 and 5 illustrate another embodiment of an air flow monitor according to the present invention, and may be used in the system 1 of FIG. 1 in place of the apparatus 10. The air flow monitoring apparatus 60 includes a base or cap 62, a filter module 77, and a housing or cap 73 similar to that described above with reference to FIGS. 2 and 3. In the embodiment illustrated in FIGS. 4 and 5, the needle/septum relationship is replaced with a self-actuating valve generally indicated at 93 provided on the inlet portion 79 of the filter module 77 in an air flow passage. The valve is adapted to be in an open position when the base portion 62 and the filter module 77 are engaged. When the filter module 77 is disengaged from the base portion 62, the valve is adapted to self-actuate into a closed position.

The self-actuation mechanism may be implemented in a variety of configurations. In one embodiment, the engagement of the filter module 77 to the base portion or cap 62 causes a force to be exerted on a biased spring 109, actuating the mechanism into an open position. Thus, when the filter module 77 is disengaged from the base portion or cap 62, the biased spring 109 actuates the valve into a closed position.

Considering now the monitoring apparatus 60 in greater detail with reference to FIGS. 4 and 5 of the drawings, the self-actuating valve 93 of the monitoring apparatus 60 includes a tubular valve body 96 having external threads 98 for engaging complementary internal threads in the base or cap 62 to secure the self-actuating valve 93 in position. The valve 93 includes a valve 101 having a pair of cross holes 103 and 105 at a bottom reduced diameter portion thereof. An annular upstanding projection 107 on the top of the filter module 77 extends into a reduced diameter opening 108 of an internal air passage 111 of the valve body 96 to raise the valve 101 to its open position as indicated in FIG. 5 against the force of the coil spring 109, which biases the valve member 101 downwardly into a closed position against a resilient annular seal or washer 110 forming a valve seat.

An annular nut 112 is threaded into the upper portion of the valve body 96 at 66 (FIG. 4) to enable the coil spring 109 to be compressed between the valve 101 in the nut 112. When the module 77 is removed from the base or cap 62, the bias coil spring 109 abruptly forces an annular shoulder of the valve 101 against the annular seal 110 to close off the passage 111. In this regard, the reduced-diameter bottom portion having the cross-holes 103 and 105 are disposed within the reduced diameter opening 108 as shown in FIG. 5 when the self-actuating valve 93 is in its closed position. The housing 73 is disassembled from the base or cap 62 by manually unthreading the internal threads 68 on a skirt portion of the base 62 with external threads 84 at the upper portion of the housing 73 as indicated in FIG. 5.

When the filter module 77 is disassembled from the base or cap 62, the valve member 101 closes into its closed position as indicated in FIG. 5 for sealing off the opening 31 (FIG. 5) in the pre-filter wall 30 to prevent the leakage of possible contaminated air from escaping from the pre-filter chamber 3 (FIG. 1). The filter module 77 can then be removed from the base 62 and the housing 73 so that a monitoring filter 88 disposed therein can be examined at a laboratory or other such facility.

Considering now the manner in which the filter module 77 is removed from the base 62 and the housing 73 with reference to FIG. 5, the tube 26 secured to a filter module outlet 91 at the bottom thereof extending through an opening 75 in the bottom of the housing 73, is detached from the outlet 91 and replaced with a tube or conduit 114 of a hand-held suction pump 116. The pump 116 is activated to help draw the air and any contaminants against the internal filter 88 during the removal process to help retain any contaminants within the interior of the module 77.

Thereafter, the housing 73 is threadably disengaged from the base 62, thereby causing the valve member 101 to abruptly and forcibly move into a closed position against the valve seat seal 110 to close off the opening 31 in the pre-filter chamber wall 30. Thereafter, a cap or seal (not shown) is secured over the inlet portion 79 of the module 73, and the pump tube 114 is removed from the module outlet 91. A cap (not shown) similar to the cap 45 of FIG. 3, is then secured over the module outlet 91. Thereafter, a module 77 can be withdrawn entirely from the housing 73 and then sent to a laboratory or other facility for examination of the filter 88. This examination will then determine whether or not the main filter 6 can be cleaned or changed in a safe manner by maintenance personnel.

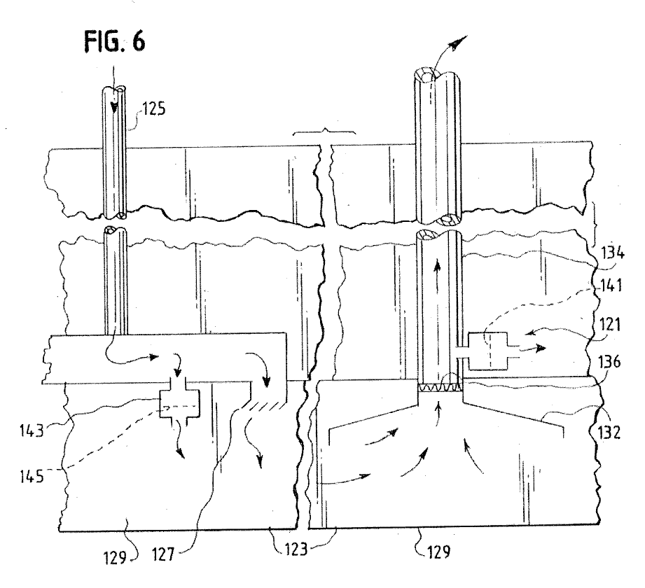

Referring now to FIG. 6, there is shown a system 121 which is constructed in accordance with another embodiment of the invention, and which is installed within a confined structure such as a clean room of a building 123. The air handling system of the building 123 includes an outside air inlet 125 disposed above the roof line of the building 123 to direct outside air through a damper 127 into a room such as a clean room 129. A fume hood 132 collects air from the room 123 by a fan (not shown) in a conventional manner to exhaust the air through a port or duct 134 to the atmosphere above the roof line of the building 123.

An air filter 136 in the port or duct 134 at the fume hood 132 filters the air being exhausted to the atmosphere. In accordance with an embodiment of the invention, an air quality monitoring apparatus 138 having a monitoring filter 141 monitoring is used to determine the build up of pollutants in the filter 136 so that it can be determined whether or not it is safe for maintenance personnel to clean or replace the air filter 136. The monitoring apparatus 138 may be constructed similar to the apparatus 10 (FIGS. 2 and 3) or similar to the apparatus 60 (FIGS. 4 and 5). In this regard, the apparatus 141 includes a valve number which either seals off the opening in the duct 134 in a self-actuated manner such as with the use of the apparatus 60, or seals off the interior of the apparatus 138 in a self-actuated manner as described in connection with the apparatus 10. It should be understood that the monitoring apparatus 138 is disposed downstream of the filter 136, as compared to the location of the monitoring apparatus in FIG. 1 being disposed upstream of the air filter for the confined structure.

An air quality monitoring apparatus 143 having a monitoring filter 145 is positioned adjacent to the damper 127 to monitor the incoming air quality to determine whether or not polluted air from the exhaust port or duct 134 is entering the outside air inlet 125. The apparatus 143 includes a removable filter module, but may or may not employ a valve member similar to the valve members described in connection with the apparatus 10 and the apparatus 60.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented

What is claimed is:

1. A system for monitoring air quality in a confined structure having an air filter disposed in an air conduit, comprising:
means defining an opening in the conduit;
a monitoring apparatus disposed in fluid communication with the opening for receiving air from the conduit to determine whether the filter has come into contact with unsafe pollutants;
said apparatus including a removable monitoring filter for monitoring air quality of air flowing through the opening; and
said apparatus having a valve device for sealing off the conduit opening when said filter is removed for examination thereof.

2. A system according to claim 1, wherein said monitoring apparatus is coupled to the air conduit at said opening upstream of the air filter.

3. A system according to claim 2, wherein said monitoring apparatus includes an inlet connected in fluid communication with the air conduit opening, said apparatus including an outlet, tube means connecting said outlet in fluid communication downstream of the air filter.

4. A system according to claim 1, wherein said monitoring apparatus is coupled to the air conduit at said opening downstream of the air filter.

5. A system according to claim 1, wherein said monitoring filter is a filter module.

6. A system according to claim 1,
wherein said monitoring apparatus includes a body having an inlet and an outlet, said inlet connected in fluid communication with the air conduit opening;
said body having an air passage there through in fluid communication with said inlet and said outlet;
said removable filter mounted within said passage; and
a valve member for self-actuating when said monitoring filter is removed for examination purposes.

7. A system according to claim 6, further including a valve seat for permitting an air flow through said monitoring filter; and
said valve member for sealing off said valve seat to seal the conduit opening when said monitoring filter is removed for examination thereof.

8. A system according to claim 6, wherein said valve member is a septum for helping to seal off said monitoring filter.

9. A method of monitoring air quality in a confined structure having an air filter disposed in a conduit, comprising:
receiving air from the conduit through an opening therein to determine whether the filter has come into contact with unsafe pollutants;
monitoring air quality of air flowing through the opening with a monitoring filter, removably mounted in fluid communication with the opening; and
sealing off the conduit opening when said monitoring filter is removed for examination thereof.

10. A method according to claim 9, further including coupling said monitoring apparatus at said opening upstream of the air filter.

11. A method according to claim 9, further including connecting in fluid communication with an inlet of said monitoring apparatus, with the air conduit opening, and connecting an outlet of said monitoring apparatus in fluid communication downstream of the air filter.

12. A method according to claim 9, further including coupling to the conduit downstream of the air filter.

13. A method according to claim 9, wherein said monitoring filter is a filter module.

14. A method according to claim 9, wherein said monitoring apparatus includes a body having an inlet and an outlet, said, inlet connected in fluid communication with the air conduit opening;
said body having an air passage there through in fluid communication with said inlet and said outlet;
said removable filter mounted within said passage; and
a valve member for self-actuating when said monitoring filter is removed for examination purposes.

15. Air monitoring apparatus for connection to an opening in an air conduit containing air filter for removing pollutants from air moving within a confined structure, comprising:
a body having an inlet and an outlet, said inlet adapted to be connected in fluid communication with the air conduit opening;
said body having an air passage therethrough in fluid communication with said inlet and said outlet;
a removable monitoring filter mounted within said passage for monitoring air quality of air flowing through the opening and into said passage; and
a valve member for self-actuating when said monitoring filter is removed for examination purposes.

16. Air monitoring apparatus according to claim 15, further including:
a valve seat for permitting air flow through said monitoring filter; and
said valve member for sealing off said valve seat to seal the conduit opening when said monitoring filter is removed for examination thereof.

17. Air monitoring apparatus according to claim 16, further including resilient means for biasing said valve member toward said valve seat, a filter module being disposed within said air passage and containing said monitoring filter, said module having a valve actuator for holding said valve member away from said valve seat in an open position away from said valve seat against the force of said resilient means.

18. Air monitoring apparatus according to claim 15, wherein said valve means includes a septum, and further including a needle inlet for piercing said septum to open it to fluid communication with said passage.

19. Air monitoring apparatus according to claim 15, wherein said monitoring filter is disposed within a removable module, further including a suction pump for maintaining pollutants within said module when it is removed for examination of the monitoring filter.

20. Air monitoring apparatus according to claim 19, further including seals for closing off the inlets and outlets of said module.
